(19) United States
(12) Patent Application Publication
(10) Pub. No.: US 2015/0081136 A1
(43) Pub. Date: Mar. 19, 2015

(54) Personal Safety Device System and Method

(71) Applicants: Michael J. Sutherland, Wylie, TX (US); John W. Darlington, Dallas, TX (US); Russell L. Spinks, Dallas, TX (US)

(72) Inventors: Michael J. Sutherland, Wylie, TX (US); John W. Darlington, Dallas, TX (US); Russell L. Spinks, Dallas, TX (US)

(21) Appl. No.: 14/549,084

(22) Filed: Nov. 20, 2014

Related U.S. Application Data
(63) Continuation-in-part of application No. 13/896,354, filed on May 17, 2013.

(51) Int. Cl. B60H 1/00; B60W 40/08; G08B 21/02

(52) U.S. Cl. CPC B60H 1/00742; G08B 21/02; B60W 40/08; B60W 2040/0818; B60W 2540/26
USPC 701/2

(57) ABSTRACT

An automated personal safety system and method for detecting and communicating unsafe temperature conditions in an automobile is disclosed. The system/method includes a device comprising a temperature sensing unit that senses human body temperature and ambient temperature. A controller in the device detects changes between a programmed threshold temperature and sensed temperatures. When in an automobile, the device communicates unsafe conditions to an automobile electronics panel that reacts accordingly to alleviate the unsafe conditions before any support arrives to the automobile. The temperature data is also constantly monitored by a third party at a remote location. Another embodiment includes a system to detect device malfunctioning in real time and react accordingly to provide assistance.

### CROSS REFERENCE TO RELATED APPLICATIONS

This application is a continuation-in-part application of non-provisional patent application Ser. No. 13/896,354, entitled A PERSONAL SAFETY DEVICE, filed May 17, 2013, the technical disclosure of which is hereby incorporated by reference in its entirety.

### FIELD OF THE INVENTION

The present invention relates to a personal safety device and more particularly to a personal safety device which measures temperatures of a user and provides an alarm. The present invention relates to methodology and apparatus for detecting the location of a user and for detecting changes in body temperature of the user and reacting to the changes accordingly in an automobile.

### PRIOR ART AND BACKGROUND OF THE INVENTION

### Prior Art Background

U.S. Pat. No. 6,353,396 discloses an apparatus and method for the early detection of increased performance impairment, incapacitation or drowsiness of a person, particularly of a person gripping an object such as a steering wheel. A wrist band is worn by the person and an electrical sensor is pressed against the person's skin by the band to sense physiological conditions by detecting various parameters at the wrist and analyzing them to provide an indication of the onset of drowsiness in the person. Some of the parameters analyzed include EMG, temperature, response to stimulation and muscular activity at the wrist. A description of a shock-absorbing wrist monitor is disclosed.

U.S. Pat. No. 7,035,736 discloses a portable personal data processing device, such as a wrist-worn measuring device, a heart rate monitor, a subscriber terminal of a radio system, or a sports watch. The device includes a temperature sensor for measuring the ambient temperature and a humidity sensor for measuring the ambient humidity. Furthermore, dependence information, which defines temperature values of the dew points corresponding to the humidity values, is stored in the device. The control unit is configured to monitor the change rate of the measured temperature, to determine, on the basis of the change rate, the moment at which the temperature reaches the temperature value of the dew point corresponding to the measured humidity on the basis of the dependence information, and to provide a forecast on fog appearance in relation to the moment employing the user interface.

U.S. Pat. No. 6,265,978 discloses an apparatus and method for the early detection of increased performance impairment, incapacitation or drowsiness of a person, particularly of a person gripping an object such as a steering wheel. A wrist band is worn by the person and an electrical sensor is pressed against the person's skin by the band to sense physiological conditions by detecting various parameters at the wrist and analyzing them to provide an indication of the onset of drowsiness in the person. Some of the parameters analyzed include EMG, temperature, response to stimulation and muscular activity at the wrist. A description of a shock-absorbing wrist monitor is disclosed.

U.S. Pat. No. 6,081,194 discloses a signal transmitting and receiving bracelet system for notifying a user wearing a receiving bracelet that a user wearing a transmitting bracelet is in danger. The signal transmitting and receiving bracelet system includes a transmitting bracelet that has sensing and transmitting circuitry having a pressure transducer adapted for contacting a pulse point of a wrist of a user for sensing a pulse of a user. The sensing and transmitting circuitry also has a transmitter that is electrically connected to the pressure transducer to emit a first signal when a user's pulse rate is higher than a predetermined rate. A receiving bracelet has receiving circuitry with a receiver adapted for receiving signals emitted from the transmitting bracelet. The receiving circuitry has a sound emitting device that is electrically connected to the receiver for emitting a sound when a signal is received from the transmitting bracelet.

U.S. Pat. No. 5,917,415 discloses a wrist worn device and method for monitoring and alerting the user of increased drowsiness. The device includes sensors for monitoring several physiological parameters of the user, including peripheral pulse rate variability, peripheral vasomotor response, muscle tone, peripheral blood flow and reaction time variability. If the majority of these parameters are indicative of increased drowsiness, and audio-visual alert is provided the user. The sensors are encased in a shock-absorbing unit and wirelessly transmit the sensed data.

### Deficiencies in the Prior Art

The prior art as detailed above suffers from the following deficiencies:
Prior art systems do not provide for detecting unsafe temperature changes of a human body and communicate the changes to an automobile that reacts to undesired changes accordingly.
Prior art systems do not provide for detecting unsafe ambient temperature changes of a human body and communicate the changes to an automobile that reacts to unsafe changes accordingly.
Prior art systems do not provide for communicating and monitoring human body temperature.
Prior art systems do not generally provide an automatic alert system upon detecting unsafe temperature changes in a human body or the ambient temperature.
Prior art systems do not generally provide for an automatic equipment malfunction/service detection and alert system.
Prior art systems do not generally provide for real time status updates to key emergency authorities upon detecting unsafe temperature changes in a human body or the ambient temperature.

While some of the prior art may teach some solutions to several of these problems, the core issue of dynamically detecting temperature changes, coordinating, real-time updates, and monitoring has not been addressed by prior art.

### OBJECTIVES OF THE INVENTION

Accordingly, the objectives of the present invention are (among others) to circumvent the deficiencies in the prior art and affect the following objectives:
Provide for detecting undesired temperature changes of a human body and communicate the changes to an automobile that reacts to undesired changes accordingly.
Provide for detecting undesired ambient temperature changes acting on a human body and communicate the changes to an automobile that reacts to undesired changes accordingly.
Provide for communicating and monitoring human body temperature.
Provide an automatic alert system upon detecting undesired temperature changes in a user's body or the ambient temperature.
Provide for an automatic equipment malfunction/service detection and alert system.
Provide for real time status updates to key emergency authorities upon detecting undesired temperature changes in a user's body or the ambient temperature.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### System Overview

The present invention in various embodiments addresses one or more of the above objectives in the following manner. The present invention dynamically detects temperature changes and reacts accordingly during unsafe conditions. The system includes a device comprising a temperature sensing unit that senses a user's body temperature and ambient temperature. A controller in the device detects changes between a programmed threshold temperature and sensed temperatures. When in an automobile, the device communicates unsafe conditions to an automobile electronics panel that reacts accordingly to alleviate the unsafe conditions before any support arrives to the automobile. The temperature data is also constantly monitored by a third party at a remote location. Another embodiment includes a system to detect device malfunctioning in real time and react accordingly to provide assistance.

### Method Overview

The present invention system may be utilized in the context of an overall personal safety method, wherein the personal safety device system described previously is controlled by a method having the following steps:
(1) programming the threshold temperature into the device;
(2) sensing a temperature with the temperature sensing unit;
(3) calculating the temperature delta between the sensed temperature and the threshold temperature;
(4) determining if the temperature delta identifies unsafe conditions;
(5) transmitting a signal to the automotive electronic system; and
(6) reacting to the unsafe conditions and taking necessary action to alleviate the unsafe conditions.

Integration of this and other preferred exemplary embodiment methods in conjunction with a variety of preferred exemplary embodiment systems described herein in anticipation by the overall scope of the present invention.

### BRIEF DESCRIPTION OF THE DRAWINGS

For a fuller understanding of the advantages provided by the invention, reference should be made to the following detailed description together with the accompanying drawings wherein:

FIG. 1 illustrates a circuit diagram of the present invention.

FIG. 2 illustrates the personal safety device in a wireless network.

FIG. 3 illustrates the personal safety device with an interface receiver.

FIG. 4 illustrates the personal safety device with a global positioning system.

FIG. 5 illustrates a personal safety device with a temperature sensor bank.

FIG. 6 illustrates a personal safety device on a band.

FIG. 7 illustrates an exemplary personal safety system worn around a human wrist positioned in an automobile describing a presently preferred embodiment of the present invention.

FIG. 8 illustrates an exemplary personal safety system overview diagram describing a presently preferred embodiment of the present invention.

FIG. 9 illustrates a personal safety device system in an automobile describing a presently preferred embodiment of the present invention.

FIG. 10 illustrates a personal safety notification method exemplary overview flowchart describing a presently preferred exemplary embodiment of the present invention.

FIG. 11 illustrates a personal safety monitoring method exemplary overview flowchart describing a presently preferred exemplary embodiment of the present invention.

FIG. 12 illustrates a personal safety reaction method exemplary overview flowchart describing a presently preferred exemplary embodiment of the present invention.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a personal safety device system and method. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

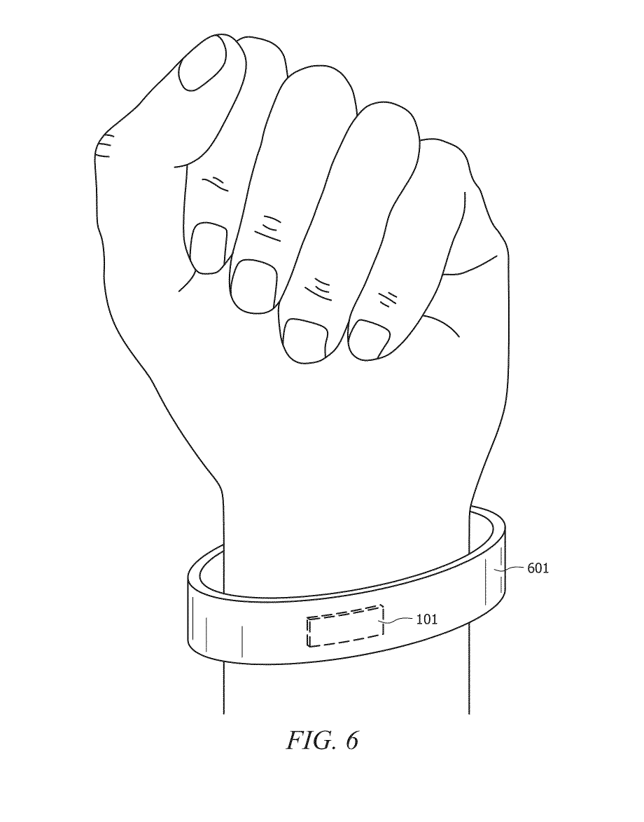

The present invention includes a personal safety device (101) or apparatus which may be worn by the user for example around the neck or ankle of the user and which may be attached to a band (601) shown in FIG. 6 or the personal safety device may be pinned to clothing of the user. In alternate embodiments, the user may be non-human. Thus, where the user is an animal, the personal safety device (101) may be affixed to the user's collar, harness, leash, or article of clothing.

The present invention may record and or transmit upper or lower exposure temperatures of the user who is using the personal safety device, and the present invention may record and transmit the ambient temperature associated with the user of the personal safety device, the skin temperature of the user who is using the personal safety device and/or the combination of the ambient temperature and the skin temperature of the user. If the temperature recorded by the personal safety device reaches or exceeds an upper or lower exposure predetermined threshold temperature limit for a predetermined length of time, the personal safety device may activate an audible alarm of the personal safety device, send a message such as a text message to a nearby receiver by blue tooth or other network capabilities and send an alert (audio or text) by cellular service to one or more telephone numbers or any combination of the three.

The personal safety device of the present invention may include a device to include a global positioning system GPS to provide a physical location of the user of the personal safety device at any time, and the movement of the personal safety device may be disabled during rigorous activity in order to prevent the transmission of a false signal.

The personal safety device of the present invention can be reprogrammed by a reprogramming device by the user of the personal safety device, can be reprogrammed remotely by a Bluetooth connection more from a computer or smart phone and can be reprogrammed by a network administrator. The predetermined threshold temperature may be adjusted by the reprogramming device.

The personal safety device may be locked onto the user to prevent the personal safety device from being removed from the user so that it can be only removed by a key.

The personal safety device of the present invention may be inserted into a body piercing (like an earring) in order to achieve better temperature measurements and may be inserted completely under the skin of the user so that the personal safety device can only read body temperature.

The personal safety device of the present invention may be incorporated into a watch such as a wrist watch or other type of band.

The personal safety device of the present invention may include an electronic display in order to display information such as the current skin temperature.

The personal safety device of the present invention may be formed with a sports helmet such as a football helmet or other types of clothing in order to monitor the temperature of the helmet or clothing in an effort to prevent hypothermia.

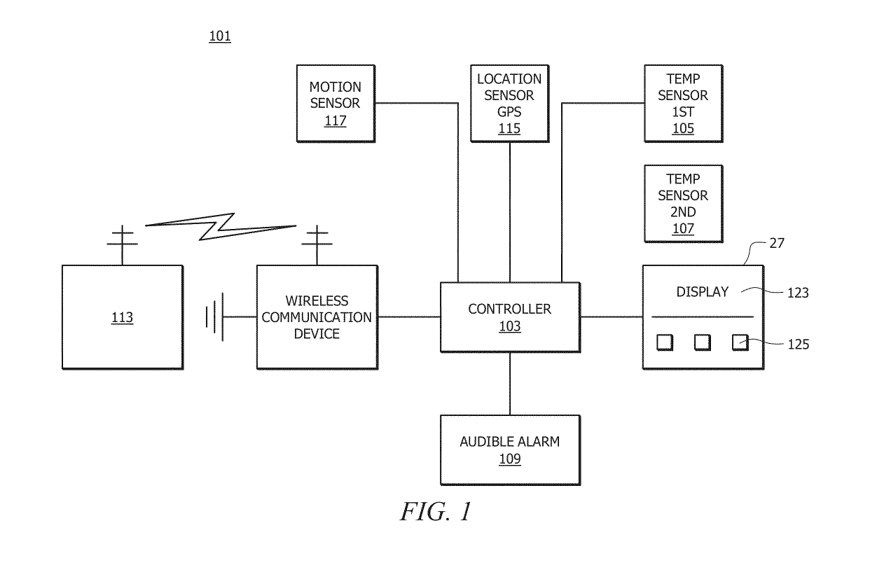

FIG. 1 illustrates a circuit diagram of the personal safety device (101) which may include a controller (103) to control the personal safety device (101). The controller (103) may be connected to a multitude of temperature sensors which may include a first temperature sensor (105) and may be connected to a second temperature sensor (107) which may be placed on different locations on the user of the personal safety device (101) in order to provide a diversity of temperatures.

The controller (103) may be additionally connected to an audible alarm device (109) which may be activated by the controller (103) if the first temperature sensor (105) or the second temperature sensor (107) exceeds a range either plus or minus from a predetermined threshold temperature. Furthermore, the controller (103) may be additionally connected to a wireless communication device (111) (transmitter) which may form a Bluetooth connection or wireless connection from the controller (103) to a wireless receiver and transmitter (a remote device) (113) to receive temperature information including alarm information from the first temperature sensor (105) and or the second temperature sensor (107) and location information obtained from the location sensor (115) which may be a GPS device. The wireless receiver and transmitter (113) may transmit information to the controller (103) in order to change values such as the predetermined threshold temperature. In addition, the controller (103) may receive motion information from the motion sensor (117) in order to deactivate the alarm information from being sent to the remote device (113) when the motion sensor (117) detects motion which exceeds a predetermined motion value which may correspond to vigorous exercise which may naturally raise the temperature of the user.

The controller (103) may be connected to a reprogramming device (121) to allow the user to reprogram the controller (103) by changing the predetermined motion value or the predetermined threshold temperature. The reprogramming device (121) may include a display (123) to display information from the controller (103) and may include a keyboard (125) to input information into the controller (103).

Furthermore, the remote device (113) may include a transmitter to transmit reprogramming information including the predetermined motion value or the predetermined threshold temperature to the wireless communication device (111) which will reprogram the controller (103).

The location sensor (115) may be a GPS device and may provide location information of the user to the controller (103).

The motion sensor (115) may provide motion information of the user to the controller (103). When the motion information exceeds a motion threshold value, the controller (103) may conclude that the user has engaged in heavy activity so that an increase in temperature from the temperature sensors (105, 107) can be safely ignored and will not activate the audible alarm (109).

In operation, the first temperature sensor (105) and the second temperature sensor (107) sense temperature data from the user and transmit the temperature data to the controller (103), and the location sensor (115) determines the location of the user and transmits location information to the controller (103). Additionally, the motion sensor (117) senses the motion of the user and transmits motion information to the controller (103). If the temperature information exceeds the predetermined threshold temperature, and if the motion information is not exceeding a predetermined threshold motion value, the controller (103) activates the wireless communication device (111) to send an alarm to the remote device (113) to allow a second user to be notified of the temperature change of the user. In addition, the controller (103) activates the audible alarm (109) to provide an audible alarm signal. If the motion information exceeds the predetermined threshold motion value, then the controller (103) will not activate the communication device 111 or the remote device (113).

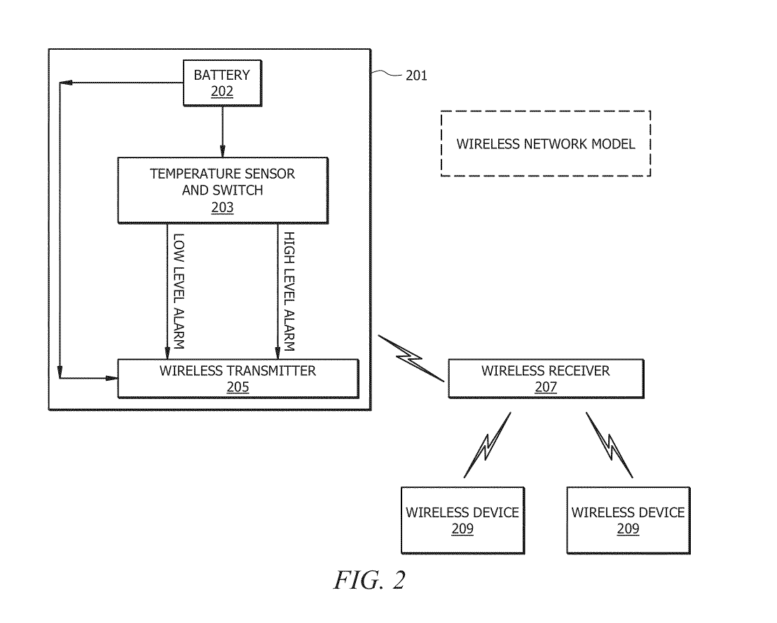

FIG. 2 illustrates another personal safety device (201) which may include a battery (202) to supply power to the temperature sensor and switch (203) and the wireless transmitter (205). The temperature sensor and switch (203) may send a first signal which may be a high level alarm to the wireless transmitter (205) when the temperature of the user exceeds a first predetermined threshold temperature and a second signal which may be a low level alarm to the wireless transmitter (205) when the temperature of the user drops below a second predetermined threshold temperature.

The wireless transmitter (205) receives the first signal and or the second signal from the temperature sensor and switch (203) and transmits the first signal or the second signal to a wireless receiver (207) which may be remote from the personal safety device (201). The wireless receiver (207) may transmit the received signal from the wireless transmitter (205) to a wireless device (209) which may receive the first signal or the second signal which may be communicated to a second user.

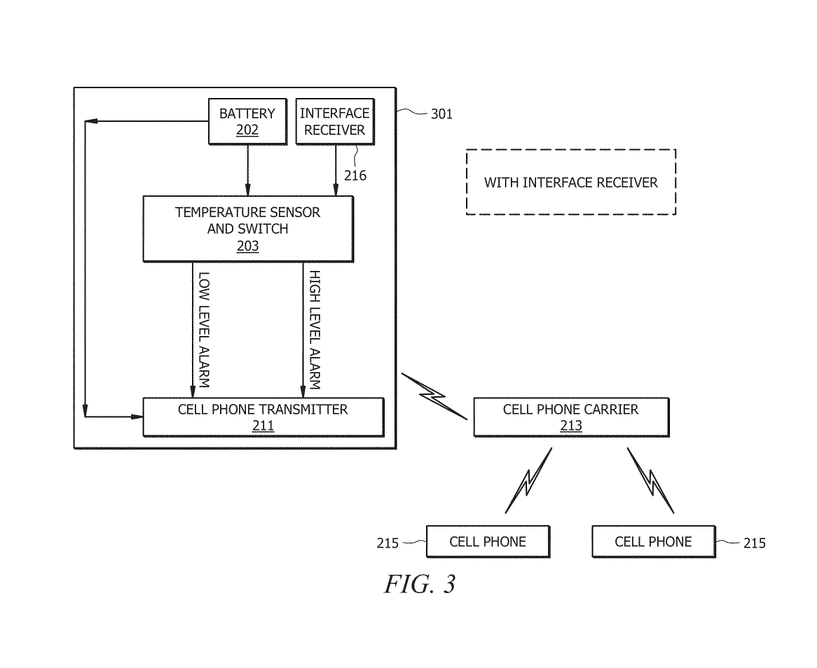

FIG. 3 illustrates another personal safety device (301) which may include a battery (202) to supply power to the temperature sensor and switch (203), the interface receiver (216) and the cell phone transmitter (211). The temperature sensor and switch (203) may send a first signal which may be a high level alarm to the cell phone transmitter (211) when the temperature of the user exceeds a first predetermined threshold temperature and a second signal which may be a low level alarm to the cell phone transmitter (211) when the temperature of the user drops below a second predetermined threshold temperature.

The cell phone transmitter (211) receives the first signal and/or the second signal from the temperature sensor and switch (203) and transmits the first signal or the second signal to a cell phone carrier (213) which may be remote from the personal safety device (301). The cell phone carrier (213) may transmit the received signal from the cell phone transmitter (211) to a cell phone (215) which may receive the first signal or the second signal which may be communicated to a second user.

The second user may transmit a replacement first predetermined threshold temperature and a replacement second predetermined threshold temperature from the cell phone (215) to the cell phone carrier (213), and the cell phone carrier (213) may transmit the replacement first predetermined threshold temperature and the replacement second predetermined threshold temperature to the interface receiver (216) which may be positioned within the personal safety device (301). The interface receiver (216) may transmit the first predetermined threshold temperature and the second replacement predetermined threshold temperature to the temperature sensor and switch (203) to replace the first and second predetermined threshold temperature.

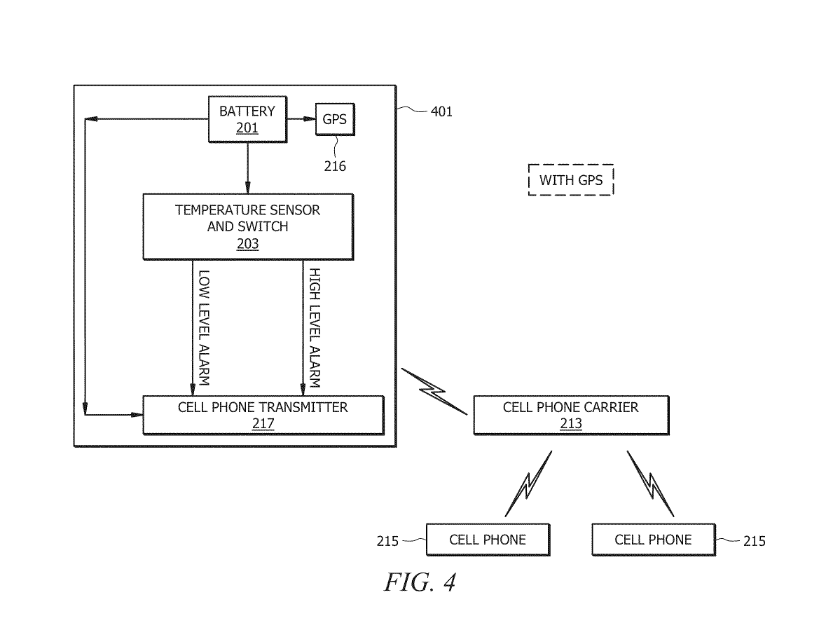

FIG. 4 illustrates another personal safety device (401) which may include a battery (202) to supply power to the temperature sensor and switch (203), the global positioning satellite device (GPS) (216) and the cell phone transmitter (211). The temperature sensor and switch (203) may send a first signal which may be a high level alarm which may include position data of the personal safety device (401) to the cell phone transmitter (211) when the temperature of the user exceeds a first predetermined threshold temperature and a second signal which may be a low level alarm which may include position data of the personal safety device (401) to the cell phone transmitter (211) when the temperature of the user drops below a second predetermined threshold temperature.

The cell phone transmitter (211) receives the first signal and or the second signal from the temperature sensor and switch (203) and transmits the first signal or the second signal to a cell phone carrier (213) which may be remote from the personal safety device (301). The cell phone carrier (213) may transmit the received signal from the cell phone transmitter (211) to a cell phone (215) which may receive the first signal or the second signal which may be communicated to a second user. The second user not only receives the high or low level alarm signal but receives the location data of the user of the personal safety device (401).

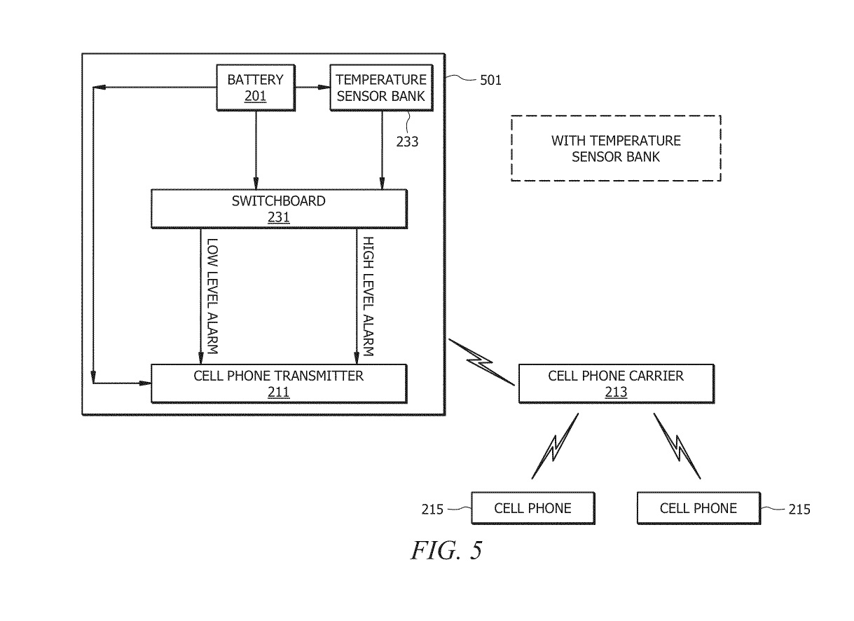

FIG. 5 illustrates another personal safety device (501) which may include a battery (202) to supply power to the switchboard (231), the temperature sensor bank (233) to measure the temperature of the body from a multitude of sensors and the cell phone transmitter (211). The switchboard (231) may send a first signal which may be a high level alarm to the cell phone transmitter (211) when the temperature of the user exceeds a first predetermined threshold temperature and a second signal which may be a low level alarm to the cell phone transmitter (211) when the temperature of the user drops below a second predetermined threshold temperature.

The cell phone transmitter (211) receives the first signal and/or the second signal from the switchboard (231) and transmits the first signal or the second signal to a cell phone carrier (213) which may be remote from the personal safety device (601). The cell phone carrier (213) may transmit the received signal from the cell phone transmitter (211) to a cell phone (215) which may receive the first signal or the second signal which may be communicated to a second user.

### Preferred Embodiment Personal Safety Device System in an Automobile Block Diagram (0700)

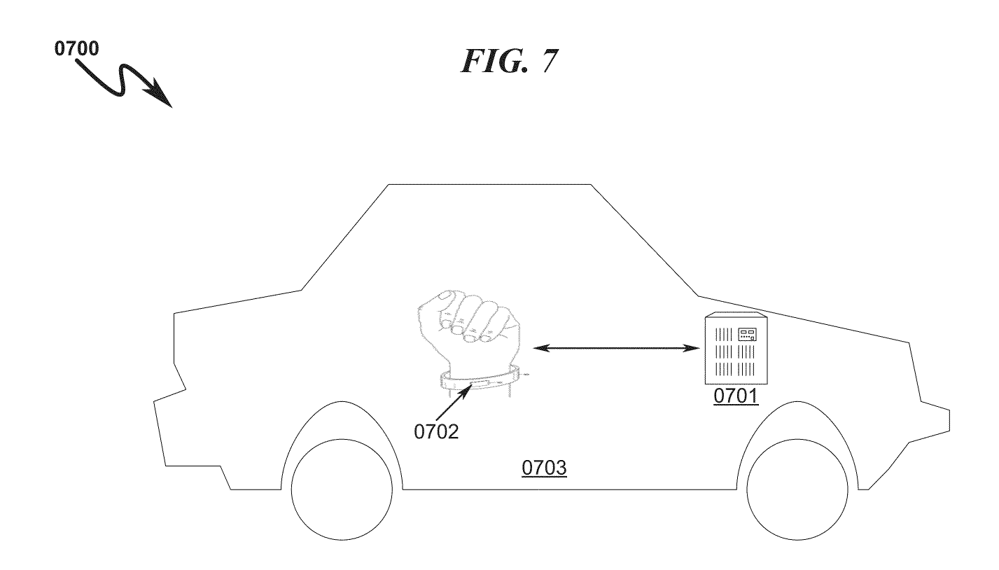

The present invention may be seen in more detail as generally illustrated in FIG. 7 (0700), wherein a user wearing a personal safety device (0702) is positioned in an automobile (0703). The personal safety device (0702) may be paired with an automobile electronics system (AES) (0701). According to a preferred exemplary embodiment, the personal safety device detects unsafe temperature conditions and communicates a signal to the AES (0701) which reacts and alleviates the unsafe temperature conditions. The AES (0701) may start the engine and turn on air conditioning, turn on hazard lights, unlock the door or inform a third party provider.

### Preferred Embodiment Personal Safety Device System Block Diagram (0800)

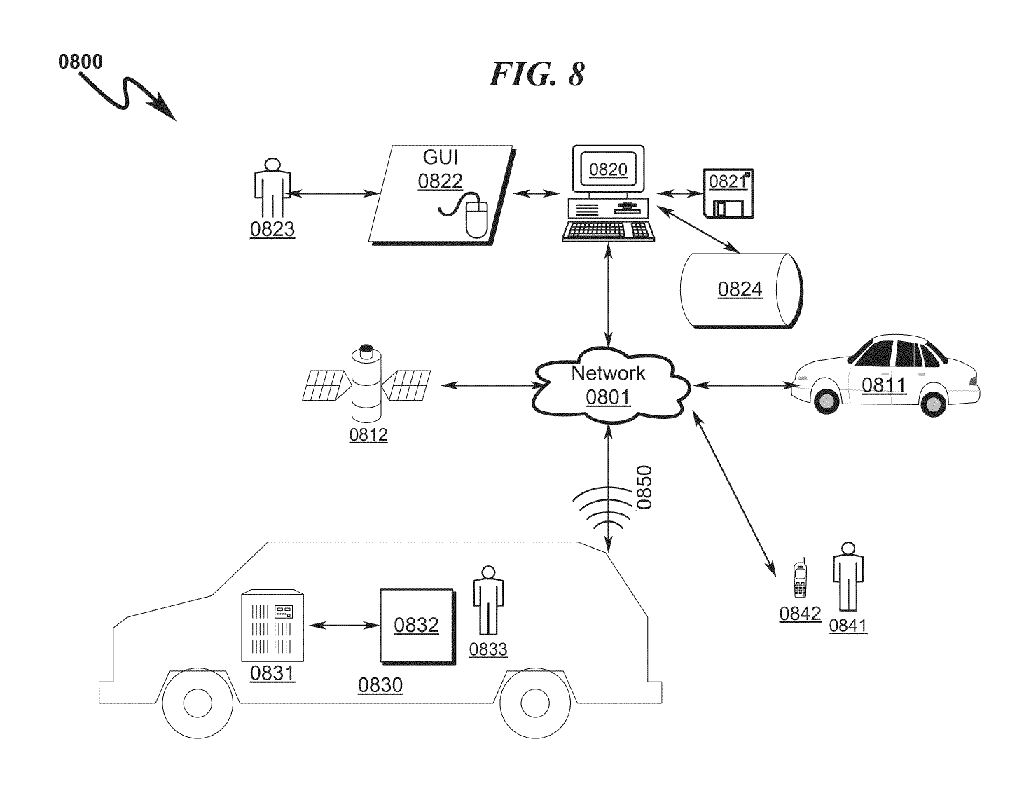

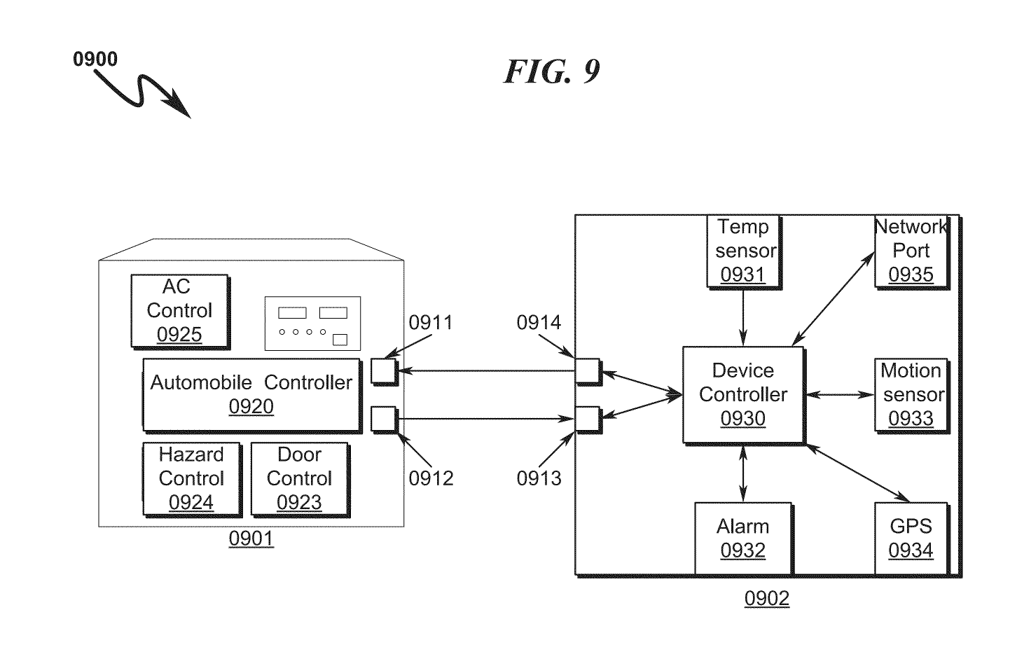

The present invention may be seen in more detail as generally illustrated in FIG. 8 (0800), wherein a user (0833) wearing a personal safety device (0832) is positioned in an automobile (0830). The safety device (0832) may be paired with automobile electronics system (AES) (0831) via generally available wireless protocols such as Bluetooth. The safety device (0832) may also be connected with the AES (0831) using a wired connection and paired using networking protocols such as Ethernet. A more detailed illustration of the device in communication with AES (0831) is shown below in FIG. 9 (0900). The safety device (0832) may also be connected to a remote third party provider that may monitor the safety device. The third party provider may send/receive commands/data to/from safety device (0832) through a network (0801). The network (0801) may include a wired protocol such as Ethernet or wireless protocol such as 3G, 4G, WIFI, NFC, WLAN, and LTE. The safety device (0832) may connect to the network (0801) through a network connection (0850). The network connection (0850) may include wireless protocol such as 3G, 4G, WIFI, NFC, WLAN, and LTE.

Third party providers/administrators may connect to the safety device (0832) through a network (0801) and configure parameters in the device such as threshold temperature, monitoring period, and/or monitoring frequency using a safety computing device (SCD) (0820). A controller in the safety device senses a user's body temperature. The controller also calculates a temperature delta (difference) between the sensed temperature and the threshold temperature. In one preferred exemplary embodiment, the safety device transmits the temperature delta information at the set monitoring frequency to SCD (0820) for a set monitoring period. The third party provider may monitor the temperature delta information and maintain a log. In another exemplary embodiment, the third party provider may detect unsafe temperature conditions in the received temperature delta and react accordingly. In one example, the threshold temperature may be set at 104° F. for human body temperature, the monitoring frequency may be set to 15 minute intervals, and the monitoring period may be set to 24 hours a day. In this scenario, if the human temperature is detected to be 105° F., the temperature delta is greater than zero which may be considered an unsafe condition for the user. The provider may then alert an emergency official (0811) such as police/EMR/Hospital or a remote user (0841) with a mobile computing device (0842). The remote user may be connected to safety device (0832) and to the network (0801). In one exemplary embodiment, the remote user may be a parent monitoring a child with the device traveling in an automobile. In another example, an elderly person with the device traveling in an automobile may be monitored by a remote user.

A controller in the safety device senses ambient temperature. The controller may also calculate a temperature delta (difference) between the sensed temperature and the threshold temperature. In one preferred exemplary embodiment, the safety device transmits the temperature delta information at the set monitoring frequency to SCD (0820) for a set monitoring period. The third party provider may monitor the temperature delta information and maintain a log. The log may be stored in a local safety database SDB (0824). In one example, the threshold temperature may be set at 100° F. for human body temperature, the monitoring frequency may be set to 15 minute intervals, and the monitoring period may be set to 24 hours a day. In this scenario, if the ambient temperature is detected to be 110° F. inside the automobile, the temperature delta may be calculated to be 10° F. which may be considered an unsafe condition for the user.

The SCD (0820) is configured for enabling third party providers to interact the safety device (0832) via network (0801). The SCD (0820) may further comprise a microprocessor executing instructions read from a computer-readable medium (0821) and a graphical user interface (GUI) (0822) with a pointing device. The providers may open GUI (0822) and select a safety database (SDB) (0824) for updating/retrieving records. The administrators may receive data through the SCD (0820) or manually.

According to a preferred exemplary embodiment, the third party provider via SCD (0820) may receive device status information periodically at a set interval to determine if the device is functioning. If the safety device does not send a signal indicating its status, the third party provider may consider it to be device malfunction and notify concerned officials and stakeholders. For example, if the device fails to send status information for three consecutive intervals, the third party provider may alert concerned officials to assist the user with malfunctioning device.

### Preferred Embodiment Personal Safety System Block Diagram (0900)

The present invention may be seen in more detail as generally illustrated in FIG. 9 (0900), wherein a personal safety device (0902) is in network communication with an automobile electronic system AES (0901). The personal safety device (0902) may comprise a device transmitter (0914), a device receiver (0913), a device controller (0930), a temperature sensing unit (0931), an alarm (0932), a motion sensor (0933), a GPS module (0934), and a network port (0935). The automobile electronic system (AES) (0901) may comprise an automobile transmitter (0912), an automobile receiver (0911), an automotive controller (0920), a door control unit (0923), a hazard control unit (0924), and an Air Conditioned control unit (0925).

A network connection (“data link”) may need to be established between personal safety device (PSD) (0902) and the AES (0901) before communicating with each other. The network connection may be a wired connection using a copper wire or a wireless connection using such protocols as Bluetooth. The wired connection may be established by a generally available protocol such as Ethernet. The device transmitter (0914) transmits data/signal to automotive receiver (0911) and conversely device receiver (0913) receives data from automotive transmitter (0912). A threshold temperature may be programmed into the PSD (0902) via a graphical interface or through the network port (0935). When the PSD (0902) is enabled to sense an ambient temperature or a user's temperature, the PSD calculates a temperature delta between the sensed temperature and the programmed threshold temperature. For example, when the calculated temperature delta is greater than 0, the device transmitter (0914) may transmit data/signal to automotive receiver (0911) indicating unsafe conditions. According to an exemplary embodiment, the automotive controller reacts to the unsafe conditions and may direct an air conditioned unit (0925) to turn on or switch on hazard lights through hazard control unit (0924) or unlock automobile doors through the door control unit (0923). The automotive controller may also sound a horn to seek attention when unsafe conditions are detected. The PSD (0902) may also alert a remote user or a third party provider through network port (0935) when unsafe conditions are detected.

### Preferred Exemplary Personal Safety Notification Method Embodiment (1000)

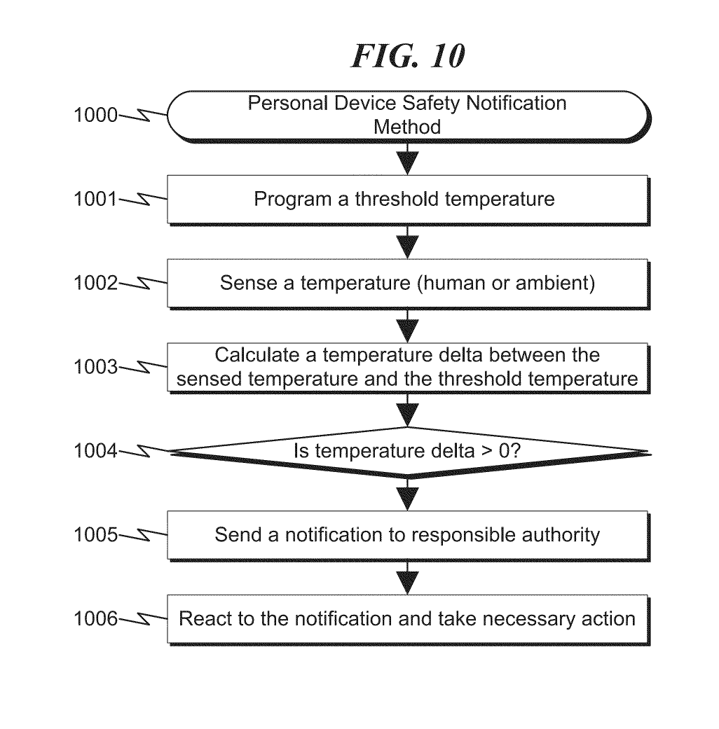

As generally seen in the flow chart of FIG. 10 (1000), a preferred exemplary personal safety notification method may be generally described in terms of the following steps:
(1) programming the threshold temperature into the device (1001);
   After the personal safety device is coupled to a user, it may be programmed on an interface or remotely through network port.
(2) sensing a temperature with the temperature sensing unit (1002);
(3) calculating the temperature delta between the sensed temperature and the threshold temperature (1003);
(4) determining if the temperature delta identifies unsafe conditions (1004);
(5) transmitting a signal to concerned authorities (1005); and
   the device may send a notification to authorities such as emergency personnel, law enforcement or to a person responsible for the device user.
(6) reacting to the unsafe conditions and taking necessary action to alleviate the unsafe conditions (1006).

### Preferred Exemplary Personal Safety Monitoring Method Embodiment (1100)

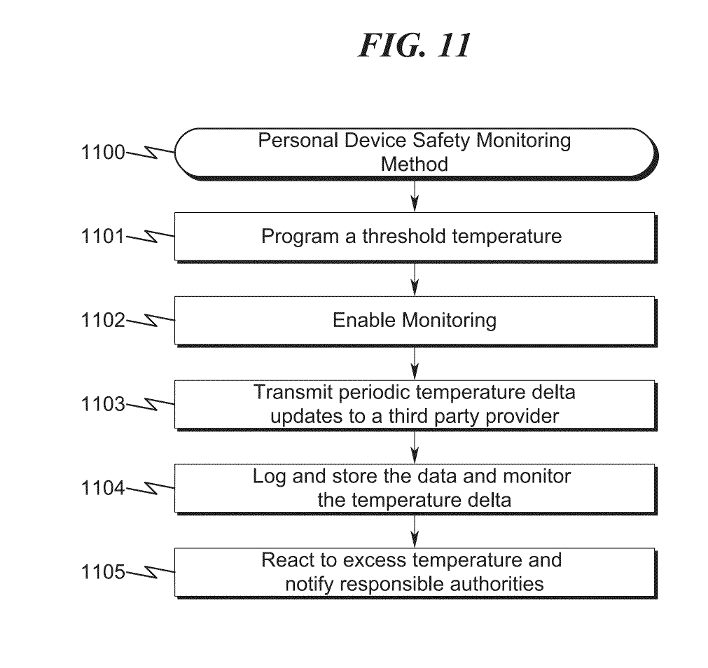

As generally seen in the flow chart of FIG. 11 (1100), a preferred exemplary personal safety monitoring method may be generally described in terms of the following steps:
(1) programming the threshold temperature into the device (1101);
   After the personal safety device is coupled to a user, it may be programmed on an interface or remotely through a network port.
(2) enabling monitoring of the temperature conditions with the device (1102);
   The device may be enabled for monitoring on an interface of the device or remotely through a network port.
(3) transmitting temperature delta updates to a third party provider(1103);
   The device senses temperature and calculates a temperature delta between the sensed temperature and the threshold temperature. The device through the network port transmits temperature delta information at a monitoring frequency for a monitoring period. The device may also transmit location information through a GPS locater on the device.
(4) Logging, storing and monitoring information (1104); and
   The third party provider logs, stores and monitors the information. The provider may also detect device malfunctioning if the temperature delta information is not received for extended period of time. For example, if the provider does not receive updates for more than one hour, the provider may take action and provide assistance to the user.
(5) reacting to the unsafe conditions and taking necessary action to alleviate the unsafe conditions (1106).

### Preferred Exemplary Personal Safety Reaction Method Embodiment (1200)

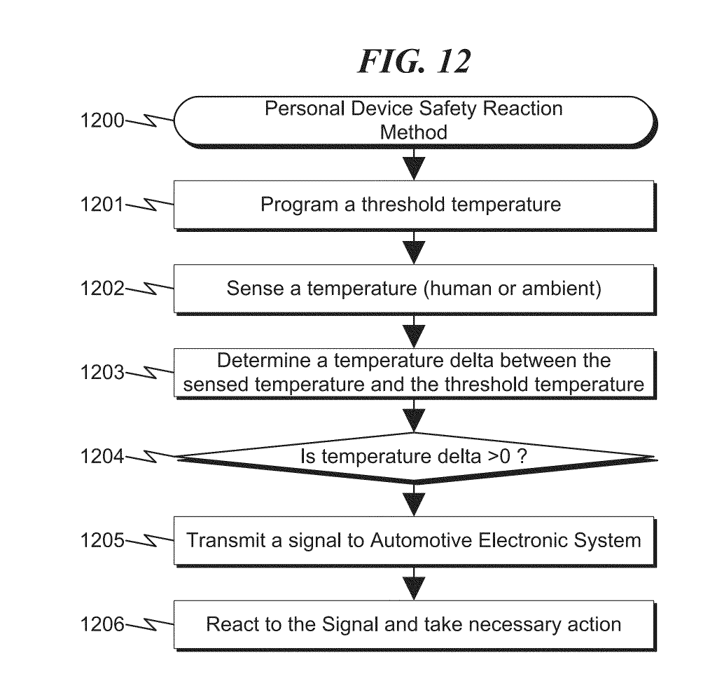

As generally seen in the flow chart of FIG. 12 (1200), a preferred exemplary personal safety notification method may be generally described in terms of the following steps:
(1) programming the threshold temperature into the device (1201);
   After the personal safety device is coupled to a user, it may be programmed on an interface or remotely through network port.
(2) sensing a temperature with the temperature sensing unit (1202);
(3) calculating the temperature delta between the sensed temperature and the threshold temperature (1203);
(4) determining if the temperature delta identifies unsafe conditions (1204);
(5) transmitting a signal to the automotive electronic system (1205); and
(6) reacting to the unsafe conditions and taking necessary action to alleviate the unsafe conditions (1206).
   the personal safety device detects unsafe temperature conditions and communicates a signal to the automotive electronic system (AES) which reacts and alleviates the unsafe temperature conditions. The AES may start the engine and turn on air conditioning, turn on hazard lights, unlock the door or inform a third party provider.

### System Summary

The present invention system anticipates a wide variety of variations in the basic theme of personal safety, but can be generalized as personal safety device system comprising:
(a) temperature sensing unit; and
(b) device controller;
wherein
the temperature sensing unit is configured to sense a temperature;
the temperature sensing unit is configured to communicate the sensed temperature to the device controller;
the device controller is configured to determine a temperature delta between the sensed temperature and a predetermined threshold temperature;
the device controller is configured to communicate a signal to an automotive electronic system via a data link, if the temperature delta identifies unsafe conditions; and
the automotive electronic system reacts to the signal to alleviate the unsafe conditions.

This general system summary may be augmented by the various elements described herein to produce a wide variety of invention embodiments consistent with this overall design description.

### Method Summary

The present invention method anticipates a wide variety of variations in the basic theme of implementation, but can be generalized as a personal safety reaction method wherein the method is performed on a personal safety device system comprising:
(a) temperature sensing unit; and
(b) device controller;
wherein
the temperature sensing unit is configured to sense a temperature;
the temperature sensing unit is configured to communicate the sensed temperature to the device controller;
the device controller is configured to determine a temperature delta between the sensed temperature and a predetermined threshold temperature;
the device controller is configured to communicate a signal to an automotive electronic system via a data link, if the temperature delta identifies unsafe conditions; and
the automotive electronic system reacts to the signal to alleviate the unsafe conditions;
wherein the method comprises the steps of:
(1) programming the threshold temperature into the device;
(2) sensing a temperature with the temperature sensing unit;
(3) calculating the temperature delta between the sensed temperature and the threshold temperature;
(4) determining if the temperature delta identifies unsafe conditions;
(5) transmitting a signal to the automotive electronic system; and
(6) reacting to the unsafe conditions and taking necessary action to alleviate the unsafe conditions.

This general method summary may be augmented by the various elements described herein to produce a wide variety of invention embodiments consistent with this overall design description.

### System/Method Variations

The present invention anticipates a wide variety of variations in the basic theme of emergency. The examples presented previously do not represent the entire scope of possible usages. They are meant to cite a few of the almost limitless possibilities.

This basic system and method may be augmented with a variety of ancillary embodiments, including but not limited to:
An embodiment wherein said sensed temperature is the skin temperature of said user.
An embodiment wherein said sensed temperature is the ambient temperature of the environment of said user.
An embodiment wherein said threshold temperature is programmed into said device with a user interface.
An embodiment wherein said threshold temperature is programmed into said device wirelessly from a remote location.
An embodiment wherein said data link is established between said device and said automotive electronic system.
An embodiment wherein said data link is wireless.
An embodiment wherein said data link is wired.
An embodiment wherein said device is further configured to provide said temperature delta to a third party provider.
An embodiment wherein device said third party provider monitors said temperature data on a predetermined schedule.
An embodiment wherein said third party provider is further configured to detect malfunction in said device.
An embodiment wherein said automotive electronic system turns on air conditioning to relieve said unsafe conditions.
An embodiment wherein said automotive electronic system unlocks said automobile to relieve said unsafe conditions.
An embodiment wherein said automotive electronic system activates a horn; said horn seeking attention to relieve said unsafe conditions.
An embodiment wherein said automotive electronic system activates an audible alarm; said alarm seeking attention to relieve said unsafe conditions.
An embodiment wherein said automotive electronic system activates a hazard lighting system; said lighting system seeking attention to relieve said unsafe conditions.

One skilled in the art will recognize that other embodiments are possible based on combinations of elements taught within the above invention description.

### CONCLUSION

An automated personal safety system and method for detecting and communicating unsafe temperature conditions in an automobile has been disclosed. The system/method includes a device comprising a temperature sensing unit that senses temperature of a user and ambient temperature. A controller in the device detects changes between a programmed threshold temperature and sensed temperatures. When in an automobile, the device communicates unsafe conditions to an automobile electronics panel that reacts accordingly to alleviate the unsafe conditions before any support arrives to the automobile. The temperature data is also constantly monitored by a third party at a remote location. Another embodiment includes a system to detect device malfunctioning in real time and react accordingly to provide assistance.

What is claimed is:

1. A personal safety device system coupled to a user positioned in an automobile, said system comprising:
(a) temperature sensing unit; and
(b) device controller;
wherein
said temperature sensing unit is configured to sense a temperature;
said temperature sensing unit is configured to communicate said sensed temperature to said device controller;
said device controller is configured to determine a temperature delta between said sensed temperature and a predetermined threshold temperature;
said device controller is configured to communicate a signal to an automotive electronic system via a data link, if said temperature delta identifies unsafe conditions; and
said automotive electronic system reacts to said signal to alleviate said unsafe conditions.

2. The personal safety device system of claim 1 wherein said sensed temperature is the skin temperature of said user.

3. The personal safety device system of claim 1 wherein said sensed temperature is the ambient temperature of an environment of said user.

4. The personal safety device system of claim 1 wherein said threshold temperature is programmed into said device with a user interface.

5. The personal safety device system of claim 1 wherein said threshold temperature is programmed into said device wirelessly from a remote location.

6. The personal safety device system of claim 1 wherein said data link is established between said device and said automotive electronic system.

7. The personal safety device system of claim 1 wherein said data link is wireless.

8. The personal safety device system of claim 1 wherein said data link is wired.

9. The personal safety device system of claim 1 wherein said device is further configured to provide said temperature delta to a third party provider.

10. The personal safety device system of claim 9 wherein device said third party provider monitors said temperature data on a predetermined schedule.

11. The personal safety device system of claim 9 wherein said third party provider is further configured to detect malfunction in said device.

12. The personal safety device system of claim 1 wherein said automotive electronic system turns on air conditioning to relieve said unsafe conditions.

13. The personal safety device system of claim 1 wherein said automotive electronic system unlocks said automobile to relieve said unsafe conditions.

14. The personal safety device system of claim 1 wherein said automotive electronic system activates a horn; said horn seeking attention to relieve said unsafe conditions.

15. The personal safety device system of claim 1 wherein said automotive electronic system activates an audible alarm; said alarm seeking attention to relieve said unsafe conditions.

16. The personal safety device system of claim 1 wherein said automotive electronic system activates a hazard lighting system; said lighting system seeking attention to relieve said unsafe conditions.

17. A personal safety notification method, said method operating in conjunction with a personal safety device system, said system comprising:
(a) temperature sensing unit; and
(b) device controller;
wherein
said temperature sensing unit is configured to sense a temperature;
said temperature sensing unit is configured to communicate said sensed temperature to said device controller;
said device controller is configured to determine a temperature delta between said sensed temperature and a predetermined threshold temperature;
said device controller is configured to communicate a signal to an automotive electronic system via a data link, if said temperature delta identifies unsafe conditions; and
said automotive electronic system reacts to said signal to alleviate said unsafe conditions;
wherein said method comprises the steps of:
(1) programming said threshold temperature into said device;
(2) sensing a temperature with said temperature sensing unit;
(3) calculating said temperature delta between said sensed temperature and said threshold temperature;
(4) determining if said temperature delta identifies unsafe conditions;
(5) notifying a responsible authority of said unsafe conditions.

18. A personal safety reaction method, said method operating in conjunction with a personal safety device system, said system comprising:
(a) temperature sensing unit; and
(b) device controller;
wherein
said temperature sensing unit is configured to sense a temperature;
said temperature sensing unit is configured to communicate said sensed temperature to said device controller;
said device controller is configured to determine a temperature delta between said sensed temperature and a predetermined threshold temperature;
said device controller is configured to communicate a signal to an automotive electronic system via a data link, if said temperature delta identifies unsafe conditions; and
said automotive electronic system reacts to said signal to alleviate said unsafe conditions;
wherein said method comprises the steps of:
(1) programming said threshold temperature into said device;
(2) sensing a temperature with said temperature sensing unit;
(3) calculating said temperature delta between said sensed temperature and said threshold temperature;
(4) determining if said temperature delta identifies unsafe conditions;
(5) transmitting a signal to said automotive electronic system, wherein the signal comprises instructions for taking necessary action to alleviate said unsafe conditions.
